(19) United States
(12) Patent Application Publication
(10) Pub. No.: US 2024/0392130 A1
(43) Pub. Date: Nov. 28, 2024

(54) ELECTROSTATIC DISSIPATIVE POLYAMIDE COMPOSITION AND ARTICLE COMPRISING IT

(71) Applicant: Solvay Specialty Polymers USA, LLC, Alpharetta, GA (US)

(72) Inventors: Jing TIAN, Shanghai (CN); Lindsey ANDERSON, Cumming, GA (US); Vijay GOPALAKRISHNAN, Cumming, GA (US)

(21) Appl. No.: 18/693,584

(22) PCT Filed: Oct. 7, 2021
(86) PCT No.: PCT/CN2021/122523

§ 371 Date: Mar. 20, 2024

(51) Int. Cl. C08L 77/06; C08J 3/20; C08K 3/04; C08K 7/06; C08K 13/04

(52) U.S. Cl. CPC C08L 77/06; C08J 3/201; C08K 13/04; C08J 2377/06; C08J 2477/02; C08J 2477/06; C08K 3/04; C08K 7/06; C08K 2201/001; C08K 2201/014; C08L 2203/20; C08L 2205/025; C08L 2205/03

(57) ABSTRACT

A polyamide composition comprising: (A) 20-69 wt % of a polyamide mixture comprising: (A1) 60-90 weight percent (wt %) of at least one semi-aromatic polyamide polymer, (A2) 10-40 wt % of at least one aliphatic polyamide polymer, (A3) 0-30 wt % of at least one aliphatic polyamide polymer different from the aliphatic polyamide polymer (A2), wherein the respective wt % of (A1), (A2) and (A3) are based on the total weight of (A1), (A2) and (A3); (B) 1-20 wt % of an electrically conducting material; (C) 30-55 wt % of glass flakes; and (D) 0-10 wt % of additive(s), wherein the respective wt % of (A), (B), (C) and (D) are based on the total weight of the polyamide composition. An article comprising such polyamide composition particularly having excellent mechanical and surface properties and being well-suited in applications with stringent dimensional tolerances and requiring ESD properties for optimal functionality.

### CROSS-REFERENCE TO RELATED APPLICATIONS

Not applicable

### TECHNICAL FIELD

The present invention relates to electrostatic dissipative polyamide compositions and also to articles including such polymer composition, such as a molded articles, particularly electronic device components.

### BACKGROUND

In electronics applications using molded parts with stringent dimensional tolerances, attempts have been made to use liquid crystalline polymers (LCPs) having a high heat resistance. To improve the mechanical properties of LCPs, a filler such as talc and milled glass may be added to improve tensile strength and modulus of elasticity. However problems are still encountered when attempting to use such materials in molded parts with small dimensional tolerance. For example, the mechanical properties are often poor or not uniform, which leads to poor filing and a lack of dimensional stability in the molded part. Furthermore, an increase in the amount of filler to improve mechanical properties can result in a surface that is too rough, which can lead to errors in the performance of the molded part in its intended application.

As such, a need exists for a polymer composition which does not contain LCPs that can be readily employed in molded parts with small dimensional tolerance, and yet still achieve good mechanical and surface properties.

Semi-crystalline polyamides have good mechanical properties and processability, making them well-suited for a variety of applications that require good mechanical performance. Polyamide molded articles are broadly used in the engineering field, in particular for electronic components as well as components in the automotive field. Due to the demand for molded articles with a reduced weight but a high mechanical strength, these articles are in general reinforced by fillers, in particular fibrous fillers. Polyphthalamides in particular are regarded for their high temperature performance, which stems from their high glass transition temperature Tg and high melting temperature Tm.

However, semi-crystalline polyamides exhibit anisotropic mold shrinkage as a result of crystallization, and fibrous reinforcing fillers, like glass fibers, amplify this effect. Additionally, dimensional stability, such as coefficient of linear thermal expansion “CLTE”, or expansion with moisture absorption, is also anisotropic, arising from the semi-crystalline polymer morphology and high aspect ratio of the reinforcing fillers.

Polyamides, like most plastic resins, are insulating materials. Indeed, plastic resins are often considered for use as electrical insulating materials, because they typically do not readily conduct electrical current and are generally rather inexpensive relative to other known insulating materials. A number of known plastics are sufficiently durable and heat resistant to provide at least some electrical insulating utility, but many such plastics are problematic due to the accumulation of electrostatic charge on the surface of the material.

Such surface charge accumulation can be undesirable for various reasons. Such materials sometimes discharge very quickly, and this can damage electronic components, or cause fires or explosions, depending upon the environment. Sudden static discharge can also be an annoyance to those using the material.

Even where sudden static discharge is not a problem, dust will typically be attracted to and will accumulate on materials carrying a static charge. Furthermore, the static charge can interfere with sensitive electronic components or devices and the like.

Resistivity can be defined as involving surface resistivity and volume resistivity. If the volume resistivity is in an appropriate range, an alternative pathway is provided through which a charge can dissipate (generally along the surface). Indeed, surface resistivity is typically the primary focus for electrostatic dissipating (“ESD”) polymeric materials.

Surface resistivity is an electrical resistance measurement (typically measured in ohms per square or “(Ω/sq”) taken at the surface of a material at room temperature. Where the surface resistivity is less than or equal to about 10⁵ Ω/sq, the composition's surface has very little insulating ability and is generally considered to be electrically conductive. Such compositions are generally poor electrostatic dissipating polymeric materials, because the rate of bleed off is too high.

Where the surface resistivity is greater than 10¹² Ω/sq, the composition's surface is generally considered to be an insulator. In certain applications, such a composition is also poor electrostatic dissipating material, because the surface does not have the requisite amount of electrical conductivity necessary to dissipate static charge. Typically where the surface resistivity is about 10⁵ to 10¹² Ω/sq, any charge contacting the surface will readily dissipate or “decay”. Further information involving the evaluation of surface and volume resistivity can be found in American Standard Test Method D257.

### SUMMARY

An objective of the present invention is thus to provide a polyamide composition which is used to make a polyamide-based article, preferably molded article, having electrostatic dissipative (ESD) properties and suitable dimensional stability, and improved mechanical properties. Specific embodiments further provide a polyamide-based molded article having improved surface properties, such as high gloss.

This combination of properties makes such article well-suited for electronic applications, and in particular well-suited as an electronic device component with stringent dimensional tolerances, smooth surface and that require ESD properties for optimal functionality.

The invention solves various problems associated with anisotropic mold shrinkage and dimensional changes (low warpage) in polyamide-based molded articles (such as components of electronic devices) which have very tight dimensional tolerances. By “warpage” is meant the deformation of molded parts in one or more directions that may be caused by anisotropic shrinkage of the resin during molding.

The invention also solves the problem of poor electrostatic dissipation in a polyamide-based article or device accumulating static charges generated during its operation by facilitating the slow dissipation of these electrostatic charges. Without an electrically conductive material, the polyamide-based article or device would be insulating and no charge dissipation would take place. On the other end, with too much electrically conductive material, the polyamide-based article or device has too low resistivity (too conductive), thereby resulting in grounding of the article or device which may inhibit its performance.

In some embodiments, the invention also solves the issues associated with surface roughness, such as low gloss, in a molded article made from a polymeric composition having a high filler content.

A first aspect of the present invention is directed to a polyamide composition comprising a polyamide mixture, an electrically conductive material and glass flakes. The polyamide composition may further comprise optional one or more additive(s) such as a reinforcing agent which is different than the glass flakes, a heat stabilizer, a lubricant, an impact modifier, a UV stabilizer, a dye, a pigment, a colorant, etc.

In some particular embodiments, the polyamide composition comprises:
A) from 35 to 50 weight percent (wt %) of a polyamide mixture comprising:
   A1) from 60 to 90 wt % of at least one semi-aromatic polyamide polymer,
   A2) from 10 to 40 wt % of at least one aliphatic polyamide polymer,
   A3) from 0 to 30 wt % of at least one aliphatic polyamide polymer different from the aliphatic polyamide polymer (A2),
wherein the respective wt % of each of the polyamides (A1), (A2) and (A3) is based on the total weight of the combination of polyamides (A1), (A2) and (A3);
B) from 1 to 20 wt % of an electrically conducting material;
C) from 30 to 55 wt % of glass flakes; and
D) from 0 to 10 wt % of additives,
   wherein the respective wt % of A, B, C and D are based on the total weight of the polyamide composition.

A second aspect of the present invention pertains to a method for making the polyamide composition according to the invention, said method comprising melt-blending the polyamide mixture (A), the electrically conductive material (B), the glass flakes (C), and any optional additive (D).

A third aspect of the present invention pertains to a molded article comprising the polyamide composition according to the invention.

A fourth aspect of the present invention pertains to an electronic device component comprising the polyamide composition according to the invention.

Another aspect of the present invention relates to a method for reducing the volume resistivity of a polyamide-based molded article, comprising melt-blending the polyamide mixture (A), the glass flakes (C), and optional additive(s) (D), with the electrically conductive material (B) to form a molding composition before subjecting the molding composition to molding, preferably injection molding, to form the molded article.

The various aspects, advantages, and features of the invention will be more readily understood and appreciated by reference to the detailed description and examples.

### Definitions

In the present descriptive specification, some terms are intended to have the following meanings.

As used herein, polyamides are generally obtained by polycondensation between at least one aromatic or aliphatic saturated diacid and at least one aliphatic saturated or aromatic primary diamine, a lactam, an amino-acid or a mixture of these different monomers.

As used herein, an aliphatic polyamide polymer includes at least 50 mol % of a recurring unit which has an amide bond (—NH—CO—) and is free of any aromatic groups. Put another way, both the diacid portion and the diamine, lactam or amino acid portion forming the polyamide's recurring units through polycondensation are free of any aromatic groups.

As used herein, a ‘semi-crystalline’ polyamide comprises a heat of fusion (“ΔH_{f}”) of at least 5 Joules per gram (J/g) measured using differential scanning calorimetry at a heating rate of 20° C./min. Similarly, as used herein, an amorphous polyamide comprises a ΔH_{f} of less than 5 J/g g measured using differential scanning calorimetry at a heating rate of 20° C./min. ΔH_{f} can be measured according to ASTM D3418. In some embodiments, the ΔH_{f} is at least 20 J/g, or at least 30 J/g or at least 40 J/g.

As used herein, a polyphthalamide (PPA) is generally obtained by polycondensation between at least one diacid and at least one diamine in which at least 55 mol % of the diacid portion of the repeating unit in the polymer chain is terephthalic acid and/or isophthalic acid, and in which the diamine is aliphatic.

The term “nano” as used herein associated with tri-dimensional structures e.g., tubes, sheets, flakes, discs, spheres, or any other 3-D structures, refers to structures having at least one dimension smaller than about 0.1 micrometer (<100 nanometers) and an aspect ratio from longest dimension to shortest dimension from about 50:1 to about 5000:1. The dimensions of nano 3-D structures can be determined by Dynamic Light Scattering (DSL) and/or direct measurement on micrographs obtained by Scanning Electron Microscopy (SEM).

In the present specification, the choice of an element from a group of elements also explicitly describes:
the choice of two or the choice of several elements from the group,
the choice of an element from a subgroup of elements consisting of the group of elements from which one or more elements have been removed.

In the passages of the present specification which will follow, any description, even though described in relation to a specific embodiment, is applicable to and interchangeable with other embodiments of the present disclosure. Each embodiment thus defined may be combined with another embodiment, unless otherwise indicated or clearly incompatible. In addition, it should be understood that the elements and/or the characteristics of a composition, a component or article, a process, a method or a use, described in the present specification, may be combined in all possible ways with the other elements and/or characteristics of the composition, component or article, process, method or use, explicitly or implicitly, this being done without departing from the scope of the present description.

In the present specification, the description of a range of values for a variable, defined by a bottom limit, or a top limit, or by a bottom limit and a top limit, also comprises the embodiments where the variable is chosen, respectively, within the range of values: excluding the bottom limit, or excluding the top limit, or excluding the bottom limit and the top limit. Any recitation herein of numerical ranges by endpoints includes all numbers subsumed within the recited ranges as well as the endpoints of the range and equivalents.

The term “comprising” (or “comprise”) includes “consisting essentially of” (or “consist essentially of”) and also “consisting of” (or “consist of”).

As used herein “consists essentially” with respect to the polyamide composition or a component thereof means that the content of ingredient(s) not explicitly recited is less than 1 wt %, or less 0.5 wt %, or less than 0.1 wt %, or less than 0.05 wt %, or less than 0.01 wt %.

The use of the singular “a” or “one” herein includes the plural unless specifically stated otherwise.

### DETAILED DESCRIPTION OF PREFERRED EMBODIMENTS

When the polyamide composition according to the invention comprises the polyamide mixture (A), the electrically conductive material (B), the glass flakes (C), and optionally additive(s) (D), it was surprisingly found that the resulting polyamide composition yields a polyamide-based molded article with electrostatic dissipative properties, improved shrinkage and/or warpage properties and/or good dimensional stability (CLTE), while exhibiting excellent mechanical performance.

The volume resistivity of the polyamide-based molded article is such that the molded article containing such polyamide composition according to the invention is an electrostatic dissipative (ESD) material. This combination of components (A), (B) and (C) with optionally (D) makes the polyamide composition according to the invention well-suited for electronic applications with stringent dimensional tolerances and that require ESD properties for optimal functionality. Preferably, the molded article containing such polyamide composition according to the invention is an electronic device component, particularly a mobile electronic device component.

In some embodiments, the polyamide-based molded article or the electronic device component, particularly a mobile electronic device component, further exhibits good surface properties, such as smooth surface measured by high gloss.

In some particular embodiments, the polyamide composition comprises:
A) from 20 to 69 wt % of a polyamide mixture comprising:
   A1) from 60 to 90 wt % of at least one semi-aromatic polyamide polymer,
   A2) from 10 to 40 wt % of at least one aliphatic polyamide polymer,
   A3) from 0 to 30 wt % of at least one aliphatic polyamide polymer different from the aliphatic polyamide polymer (A2),
wherein the respective wt % of each of the polyamides (A1), (A2) and (A3) are based on the total weight of the combination of polyamides (A1), (A2) and (A3);
B) from 1 to 20 wt % of an electrically conducting material;
C) from 30 to 55 wt % of glass flakes; and
D) from 0 to 10 wt % of additives,
   wherein the respective wt % of components (A), (B), (C) and (D) are based on the total weight of the polyamide composition.

In some embodiments, the polyamide composition according to the invention does not comprise more than 5 wt %, preferably does not comprise more than 2 wt %, more preferably does not comprise more than 1 wt %, of a polymer other than the polyamide polymers (A1), (A2) and (A3).

In some embodiments, the polyamide composition according to the invention consists essentially of the polyamide mixture (A), the electrically conductive material (B), the glass flakes (C), optionally one or more additive(s) (D).

In some particular embodiments, the polyamide composition comprises:
A) from 25 to 55 wt % of a polyamide mixture comprising:
B) from 5 to 15 wt % of an electrically conducting material;
C) from 40 to 55 wt % of glass flakes; and
D) from 0 to 10 wt % of additives,
   wherein the respective wt % of components (A), (B), (C) and (D) are based on the total weight of the polyamide composition.

In yet more particular embodiments, the polyamide composition comprises:
A) from 30 to 50 wt % of a polyamide mixture comprising:
B) from 5 to 15 wt % of an electrically conducting material;
C) from 45 to 50 wt % of glass flakes; and
D) from 0 to 10 wt % of additives,
   wherein the respective wt % of components (A), (B), (C) and (D) are based on the total weight of the polyamide composition.

In some embodiments, the polyamide composition has a melting temperature Tm of at least 300° C., at least 305° C., or at least 310° C. Additionally or alternatively, in some embodiments, the polyamide composition has a Tm of no more than 360° C., no more than 350° C., or no more than 345° C. In some embodiments, the polyamide polymer has a Tm of from 300° C. to 360° C., from 305° C. to 350° C., or from 310° C. to 345° C. Tm can be measured according to ASTM D3418.

### Polyamide Mixture (A)

The polyamide composition according to the invention comprises from 20 to 69 wt %, or from 25 to 55 wt %, or from 30 to 50 wt %, of the polyamide mixture (A) based on the total weight of the polyamide composition.

The polyamide mixture (A) comprises at least two polyamide polymers: at least one being a semi-aromatic polyamide polymer and at least another polyamide being an aliphatic polyamide polymer.

In some embodiments, at least a portion of the polyamide mixture (A) in the polyamide composition is bio-based.

The polyamide mixture (A) preferably comprises
A1) from 60 to 90 wt % of at least one semi-aromatic polyamide polymer,
A2) from 10 to 40 wt % of at least one aliphatic polyamide polymer,
A3) from 0 to 30 wt % of at least one aliphatic polyamide polymer different from the aliphatic polyamide polymer (A2),
wherein the wt % of each of the polyamides (A1), (A2) and (A3) is based on the total weight of the combination of polyamides (A1), (A2) and (A3).

In some embodiments, the polyamide mixture (A) comprises
A1) from 85 to 90 wt % of at least one semi-aromatic polyamide polymer,
A2) from 10 to 15 wt % of at least one aliphatic polyamide polymer,
wherein the wt % of each of the polyamides (A1) and (A2) is based on the total weight of the combination of polyamides (A1) and (A2).

In some embodiments, the polyamide mixture (A) comprises
A1) from 85 to 90 wt % of PA6T/66,
A2) from 10 to 15 wt % of PA12,
wherein the wt % of each of the polyamides (A1) and (A2) is based on the total weight of the combination of polyamides (A1) and (A2).

In some embodiments, the polyamide mixture (A) comprises
A1) from 60 to 65 wt % of at least one semi-aromatic polyamide polymer,
A2) from 10 to 15 wt % of at least one aliphatic polyamide polymer,
A3) from 20 to 30 wt % of at least one aliphatic polyamide polymer different from the aliphatic polyamide polymer (A2),
wherein the wt % of each of the polyamides (A1), (A2) and (A3) is based on the total weight of the combination of polyamides (A1), (A2) and (A3).

In some embodiments, the polyamide mixture (A) comprises
A1) from 60 to 65 wt % of PA6T/66,
A2) from 10 to 15 wt % of PA12,
A3) from 20 to 30 wt % of PA610,
wherein the wt % of each of the polyamides (A1), (A2) and (A3) is based on the total weight of the combination of polyamides (A1), (A2) and (A3).

In some embodiments of the polyamide mixture (A) when the aliphatic polyamide polymer (A3) is present, the weight % of the polyamide (A3) based on the combined weight of the distinct polyamides (A1), (A2) and (A3) is higher than the weight % of the aliphatic polyamide polymer (A2) based on the combined weight of the distinct polyamides (A1), (A2) and (A3).

In some embodiments of the polyamide mixture (A) not containing the aliphatic polyamide polymer (A3), the weight ratio of (A1)/(A2) may be from 5.66 to 9.0, preferably from 6.5 to 9.

In some embodiments of the polyamide mixture (A) containing the aliphatic polyamide polymer (A3), the weight ratio of polyamide (A1) to polyamides (A2)+ (A3) may be from 1.33 to 2.15, preferably from 1.5 to 2, more preferably from 1.6 to 1.8.

### Semi-Aromatic Polyamide (A1)

In some embodiments, the polyamide mixture (A) comprises from 60 to 90 wt %, preferably from 60 to 65 wt % or from 85 wt % to 90 wt %, of the semi-aromatic polyamide polymer (A1), wherein the wt % of the polyamide (A1) is based on the total weight of the combination of polyamides (A1), (A2) and (A3).

In some embodiments, the polyamide mixture (A) comprises from 60 to 65 wt %, of the semi-aromatic polyamide polymer (A1), wherein the wt % of the polyamide (A1) is based on the total weight of the combination of polyamides (A1), (A2) and (A3). Such embodiment is preferred when the polyamide mixture comprises an aliphatic polyamide (A3) different than the aliphatic polyamide (A2).

In some embodiments, the polyamide mixture (A) comprises from 85 wt % to 90 wt % of the semi-aromatic polyamide polymer (A1), wherein the wt % of the polyamide (A1) is based on the total weight of the combination of polyamides (A1), (A2) and (A3). Such embodiment is preferred when the polyamide mixture does not comprise the aliphatic polyamide (A3).

In some embodiments, the semi-aromatic polyamide (A1) comprises, or consists essentially of, a polyamide selected from the group consisting of PA10T/10I, PA6T/66, PA6T/6I, PA6I/66, PA6T/6, PA 6I/6, PA 6I/66, PA 6T/6I/66, PA 6T/6I/6, PA10T/66, PA6T, PA6I, PA9T, PA10T, PA12T, PA12I, PAMXD6, PAPXD10, and any combination thereof.

In preferred embodiments, the semi-aromatic polyamide (A1) comprises, or consists essentially of, a polyphthalamide.

In some embodiments, the semi-aromatic polyamide (A1) is a polymer obtained by polycondensation of isophthalic acid and/or a terephthalic acid component and an aliphatic diamine having from 6 to 12 carbon atoms. In the standard nomenclature, ‘T’ and ‘I’ are combined with a number indicating the length of the aliphatic monomers. For example, PA6T is derived from hexamethylene diamine and terephthalic acid. Suitable polyphthalamides for the semi-aromatic polyamide (A1) include copolymers selected from PA6T/66, PA6T/6I, PA6I/66, PA6T/6, PA6I/6, PA 6T/6I/66, PA 6T/6I/6 or any combinations thereof. Other suitable polyphthalamides for the semi-aromatic polyamide (A1) include homopolymers selected from PA6T, PA6I, PA9T, PA10T, PA12T, PA12I, or any combinations thereof.

In more preferred embodiments, the semi-aromatic polyamide (A1) comprises, or consists essentially of, a polyphthalamide selected from the group consisting of PA6T/66, PA6T/6I, PA10T/66, PA6T, PA9T, PA12T, PA6I, and any combination thereof.

In yet more preferred embodiments, the semi-aromatic polyamide (A1) comprises, or consists essentially of, PA6T/66 and optionally a polyamide selected from the group consisting of PA10T/10I, PA6T/6I, PA6I/66, PA6T/6, PA 6I/6, PA 6I/66, PA 6T/6I/66, PA 6T/6I/6, PA 10T/66, PA6T, PA6I, PA9T, PA10T, PA12T, PA12I, PAMXD6, PAPXD10 and any combination thereof. In such embodiments, more than half (by weight) of the semi-aromatic polyamide (A1) is PA6T/66.

In most preferred embodiments, the semi-aromatic polyamide (A1) consists essentially of PA6T/66.

### Aliphatic Polyamide (A2)

In some embodiments, the polyamide mixture (A) comprises from 10 to 40 wt %, preferably from 10 to 15 wt %, of at least one aliphatic polyamide polymer (A2), wherein the wt % of the polyamide (A2) is based on the total weight of the combination of polyamides (A1), (A2) and (A3).

In preferred embodiments, the aliphatic polyamide polymer (A2) comprises, or consists essentially of, PA12.

### Aliphatic Polyamide (A3)

In some embodiments, the polyamide mixture (A) comprises from 0 to 30 wt %, of at least one aliphatic polyamide polymer (A3) different from the aliphatic polyamide polymer (A2), wherein the wt % of the polyamide (A3) is based on the total weight of the combination of polyamides (A1), (A2) and (A3).

In some embodiments, the aliphatic polyamide polymer (A3) being different from the aliphatic polyamide polymer (A2) is selected from the group consisting of PA610, PA612, PA1010, PA510, PA6, PA66, PA1012, and any combination thereof.

In some embodiments, the aliphatic polyamide polymer (A3) excludes PA12.

In preferred embodiments, the aliphatic polyamide polymer (A3) being different from the aliphatic polyamide polymer (A2) is selected from the group consisting of PA610, PA612, PA510, PA6, PA66, and any combination thereof.

In more preferred embodiments, the aliphatic polyamide polymer (A3) being different from the aliphatic polyamide polymer (A2) is selected from the group consisting of PA610, PA510, PA6, PA66, and any combination thereof.

In most preferred embodiments, the aliphatic polyamide polymer (A3) being different from the aliphatic polyamide polymer (A2) comprises, or consists essentially of, PA610.

### Optional Polymer(s)

In some embodiments, the polyamide composition may comprise a polymeric carrier which is used to form a masterbatch into which an additive or/and the electrically conductive material is/are mixed prior to making the polyamide composition. In such instance, the weight content (wt %) of such polymeric carrier used as masterbatch carrier should be less than the weight content (wt %) of the polyamide mixture (A), their respective wt % being based on the total weight of the polyamide composition.

The polymeric carrier may include, or consist of, any of the polyamides (A1), (A2) and (A3) used in the polyamide mixture (A), and/or may include, or consist of, a polyolefin or a polyamide different than the polyamides (A1), (A2) and (A3) used in the polyamide mixture (A), such as PAMXD6. A PAMXD6 polymer is a polymer made from adipic acid and meta-xylylene diamine (notably commercially available as IXEF® polyarylamides from Solvay Specialty Polymers U.S.A, L.L.C.).

### Electrically Conductive Material (B)

The polyamide composition also comprises from 1 to 20 wt %, or from 5 to 15 wt %, at least one electrically conductive material (B), based on the total weight of the polyamide composition. The electrically conductive material (B) provides for improved ESD properties of the article or device or component thereof in which it is incorporated.

The electrically conductive material (B) may be of any suitable shape and morphology such as a tri-dimensional structure selected from the group consisting of continuous fibers, milled or chopped fibers either being in granulate form or not, flakes, powders, microspheres, nano-tubes, nano-particles, nano-fibers, nano-flakes, nano-ropes, nano-ribbons, nano-fibrils, nano-needles, nano-sheets, nano-rods, carbon nano-cones, carbon nano-scrolls, nano-platelets, nano-dots, dendrites, discs or any other tri-dimensional body, singly or in combination.

In some embodiments, the electrically conductive material (B) has a volume resistivity of less than 2·10⁻² Ω·cm, or at most 1·10⁻² Ω·cm, or at most 5·10⁻³ Ω·cm, or at most 3·10⁻³ Ω·cm, or at most 2·10⁻³ Ω·cm. In some embodiments, the electrically conductive material (B) has a volume resistivity of at least 1·10⁻⁴ Ω·cm. In some embodiments, the electrically conductive material (B) has a volume resistivity of from 1·10⁻⁴ Ω·cm up to 20·10⁻⁴ Ω·cm.

In some embodiments, the electrically conductive material (B) is comprised of an inorganic conductive material.

In some embodiments, the electrically conductive material (B) comprises at least one material selected from: conductive carbon black, metal flakes, metal powders, metalized glass spheres, metalized glass fibers, metal fibers, metalized whiskers, carbon fibers being optionally metalized (such as continuous carbon fibers, chopped carbon fibers, milled carbon fibers, and/or milled/chopped carbon fibers being in granulates form or not), carbon nanotubes, intrinsically conductive polymers or graphite fibrils.

In some embodiments, the electrically conductive material (B) consists essentially of a carbon-based material.

In some embodiments, the electrically conductive material (B) may comprise, or consist of, carbon-based structures selected from the group consisting of: carbon-based fibers (e.g., continuous carbon fibers, chopped carbon fibers, milled carbon fibers, and/or milled/chopped carbon fibers being in granulates form or not), carbon nano-tubes (CNTs), carbon nano-fibres, carbon nano-flakes, carbon nano-ropes, carbon nano-ribbons, carbon nano-fibrils, carbon nano-needles, carbon nano-sheets, carbon nano-rods, carbon nano-cones, carbon nano-scrolls, carbon nano-ohms, conductive carbon black powder, graphite fibrils, graphite nano-platelets, nano-dots, graphenes, and any combination of at least two or more thereof.

In some embodiments, the carbon-based structures used in the electrically conductive material (B) generally comprise at least 90 wt % carbon.

In some embodiments, the carbon-based structures used in the electrically conductive material (B) may be metalized.

In preferred embodiments, the carbon-based structures used in the electrically conductive material (B) are not metalized.

Suitable carbon-based fibers, which may be optionally metalized, include, but are not limited to, continuous carbon fibers, chopped carbon fibers, milled carbon fibers, and/or milled/chopped carbon fibers being in granulates form or not.

In preferred embodiments, the electrically conductive material (B) may comprise, or consist of, carbon nanotubes, continuous carbon fibers, chopped carbon fibers, milled carbon fibers, milled/chopped carbon fibers being in granulates form or not, conductive carbon black powder, or any combination thereof.

Carbon fibers may be continuous filaments that may be thousands of micrometers (μm) or millimeters (mm) in length, and are referred to “continuous carbon fibers” herein. A group of continuous carbon fibers is often categorized as a bundle of continuous carbon fiber filaments. Carbon fiber “tow” is usually designated as a number of filaments in thousands (designated by K after the respective tow number). Carbon fiber bundles may be chopped or milled and thus form short segments of carbon fibers (filaments or bundles).

In various aspects, continuous carbon fibers have a length of greater than or equal to about 50 mm, as compared to chopped or milled carbon fibers. In certain aspects, a continuous carbon fiber has a length of greater than or equal to about 50 mm, optionally greater than or equal to about 75 mm, optionally greater than or equal to about 100 mm, optionally greater than or equal to about 125 mm, optionally greater than or equal to about 150 mm, optionally greater than or equal to about 175 mm, optionally greater than or equal to about 200 mm, optionally greater than or equal to about 225 mm, optionally greater than or equal to about 250 mm, and in certain variations, optionally greater than or equal to about 300 mm.

Chopped or milled carbon fibers typically have a mean fiber length between 50 μm and 50 mm.

Suitable chopped carbon fibers compatible with polyamides are commercially available as CF.OS.U1-6 mm, CF.OS.U2-6 mm, CF.OS.A-6 mm, CF.OS.I-6 mm from Procotex, with an average monofilament diameter of 7 microns, a mean length of 6 mm and a volume resistivity of 15·10⁻⁴ Ω·cm up to 20·10⁻⁴ Ω·cm.

Suitable milled carbon fibers are commercially available as CF.LS-MLD80 to CF.LS-MLD250 from Procotex, with an average monofilament diameter of 7 microns, a medium length of 80-250 microns and a volume resistivity of 15·10⁻⁴ Ω·cm up to 20·10⁻⁴ Ω·cm.

Carbon nanotubes are an example of nanometer or molecular size electrically conductive materials. Carbon nanotubes can be single-walled carbon nanotubes (“SWCNT”), double-walled carbon nanotubes (“DWCNT”), multiwalled carbon nanotubes (“MWCNT”) (which consist of nested SWCNT) or a mixture thereof. Preferably, the carbon nanotubes are MWCNT. Carbon nanotubes and carbon nano-ropes such as ropes of carbon nanotubes (e.g., SWNT or MWNT and ropes of SWNT or MWNT) exhibit high mechanical strength, electrical conductivity, and high thermal conductivity. In some embodiments, the carbon nanotubes have an average aspect ratio, defined as the length over the diameter, of 100 or more. In some embodiments, the carbon nanotubes can have an average aspect ratio of 1000 or more. In some embodiments, the carbon nanotubes have an average diameter of from 1 nanometer (nm) to 3.5 nm or 4 nm (roping). In some embodiments, the carbon nanotubes have an average length of at least 1 μm.

Commercially available industrial grades of carbon-based nano-structures with a 90-95% C purity can be dispersed directly in the polyamide polymer without pre-treatment. Suitable multi-walled CNTs (MWCNTs) include Nanocyl® NC7000 MWCNT grade having purity as low as 90% C purity or Nanocyl® NC3100 MWCNT grade with a C purity to greater than 95% C purity, both from Nanocyl (Belgium). Nanocyl® NC7000 MWCNTs have an average diameter of 9.5 nanometers, a mean length of 1.5 microns, a BET surface area of 250-300 m²/g and a volume resistivity of 1·10⁻⁴ Ω·cm. Other suitable sources for carbon-based nano-structures are FRIBIL® multi-walled carbon nanotubes from Hyperion Catalysis International. These MWCNTs may have an outside diameter of about 10 nanometers and a length over 10 microns.

In some embodiments, the electrically conductive material (B) may have a specific surface area (SSA) of at least 0.1 m²/g, preferably 10 m²/g or higher, for example from about 10 m²/g to about 500 m²/g as measured by standard Brunauer-Emmett-Tellermethod (BET) measurement method. For example the BET measurement method with a Micro-metrics TriStar II with the standard nitrogen system may be used.

In some embodiments, the content of the electrically conductive material (B) in the polyamide composition is at least 1 wt %, or at least 1.5 wt % and/or at most 30 wt %, or at most 25 wt %, or at most 20 wt %, the wt % being based on the total weight of the polyamide composition.

When the electrically conductive material (B) comprises carbon fibers (which include continuous carbon fibers, chopped carbon fibers, milled carbon fibers, and/or milled/chopped carbon fibers being in granulates form or not), the carbon fibers content in the polyamide composition is at least 6 wt %, or at least 7 wt %, or at least 8 wt % based on the total weight of the polyamide composition. In some of such embodiments, the carbon fibers content is at most 20 wt %, or at most 17 wt %, or at most 15 wt %, or at most 13 wt %, at most 11 wt %, based on the total weight of the polyamide composition. In some embodiments, the carbon fibers content is from 6 wt % to 30 wt %, or from 8 wt % to 30 wt %, or from 6 wt % to 25 wt %, or from 8 wt % to 25 wt %, or from 6 wt % to 20 wt %, or from 8 wt % to 20 wt %, or from 6 wt % to 15 wt %, or from 7 wt % to 15 wt %, or from 7 wt % to 13 wt %, or from 7 wt % to 11 wt %, or from 8 wt % to 15 wt %, or from 8 wt % to 13 wt %, or from 8 wt % to 10 wt %, based on the total weight of the polyamide composition.

When the electrically conductive material (B) comprises carbon-based nano-structures such as carbon nanotubes (CNTs), the content of the carbon-based nano-structures in the polyamide composition is at least 1 wt %, or at least 1.5 wt %, based on the total weight of the polyamide composition. In some of such embodiments, the content of the carbon-based nano-structures (e.g., CNTs) is at most 10 wt %, or at most 8 wt %, or at most 7 wt %, or at most 6 wt %, or at most 5 wt %, or at most 4 wt %, or at most 3 wt %, based on the total weight of the polyamide composition. In some embodiments, the content of the carbon-based nano-structures is from 1 wt % to 5 wt %, or from 1 wt % to 4 wt %, or from 1 wt % to 3 wt %, or from 1.5 wt % to 5 wt %, or from 1.5 wt % to 4 wt %, or from 1.5 wt % to 3 wt %, or from 1 wt % to 8 wt %, or from 1.5 wt % to 8 wt %, based on the total weight of the polyamide composition.

### Glass Flakes (C)

The polyamide composition also comprises glass flakes (C).

In some embodiments, the content in glass flakes (C) is at least 30 wt %, or at least 35 wt %, or at least 40 wt %, or at least 45 wt %, based on the total weight of the polyamide composition.

In additional or alternate embodiments, the content in glass flakes (C) is at most 55 wt %, or at most 50 wt %, based on the total weight of the polyamide composition.

In some embodiments, the content in glass flakes (C) is from 30 wt % to 55 wt %, or from 30 wt % to 50 wt %, or from 35 wt % to 55 wt %, or from 35 wt % to 50 wt %, or from 40 wt % to 55 wt %, or from 40 wt % to 50 wt %, or from 45 wt % to 55 wt %, or from 45 wt % to 50 wt %, based on the total weight of the polyamide composition.

The glass flakes (C) preferably have tri-dimensional structures characterized by an average length at most 500 microns, or at most 450 microns, or at most 400 microns, or at most 350 microns, or at most 200 microns, or at most 250 microns. For the glass flakes (C) having a tri-dimensional structure, its “length” is regarded as its longest dimension.

The glass flakes (C) are preferably an electrically insulating filler, generally having a volume resistivity of more than 10⁺¹² Ω·cm or more than 5·10⁺¹² Ω·cm.

The glass flakes (C) are preferably non-fibrous. A “non-fibrous” filler is considered herein to have a tri-dimensional structure having a length, a width and thickness, wherein both length and width are significantly larger than its thickness. Generally, such glass flakes (C) having tri-dimensional structures have an aspect ratio, defined as the average length over the largest of the average width and average thickness, of at most 3, or at most 2.5, or at most 2 or at most 1.5.

In some embodiments, the glass flakes (C) may have an average thickness of from 0.4 micron to 10 microns. In some embodiments, the glass flakes (C) have an average thickness of from 0.4 micron up to 2 microns, or up to 1 micron.

The dimensions (length, width, thickness) of tri-dimensional structures can be determined by direct measurement on micrographs obtained by Scanning Electron Microscopy (SEM).

The average dimensions (i.e., length, width and thickness) of the glass flakes' tri-dimensional structures can be taken as the average length of the glass flakes (C) prior to incorporation into the polyamide composition or can be taken as the average dimensions of the glass flakes (C) in the polyamide composition.

Glass flakes (C) are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. Any glass type, such as A, C, D, E, M, S, R, T glass or mixtures thereof, preferably C or E glass, may be used in the glass filler. C glass contains alkali components and has high acid resistance. E glass contains almost no alkali and so, it has high stability in resin and no electrical conductivity.

In some embodiments, the glass flakes (C) preferably include, or consist of, glass flakes with C glass or E glass. Suitable glass flakes (C) with E or C glass are commercially available as GLASFLAKE® from NSG. E-glass flakes are particularly effective in preventing warpage and improving dimensional accuracy in precision parts made of thermoplastic polymers. FINEFLAKE® glass flakes also commercially available from NSG with an average thickness of 0.4 to 1 microns are suitable for fine and thin molded products. In some embodiments, the glass flakes may be granulated. For example, FLEKA® granulated glass flakes with E glass are commercially available from NSG.

In some embodiments, at least a portion of the glass flakes (C) may be substituted in the polyamide composition by chopped glass fibers, so long as their average length is at most 500 microns, or at most 450 microns, or at most 400 microns, or at most 350 microns, or at most 200 microns, or at most 250 microns.

In some embodiments, when the glass flakes (C) comprise both glass flakes and chopped glass fibers with average length is at most 500 microns, the glass flakes represent more than 50 wt %, or more than 60 wt %, or more than 70 wt %, or more than 80 wt %, the wt % being based on the combined weight of glass flakes and chopped glass fibers in (C).

In some embodiments when the glass flakes (C) further comprise chopped glass fibers, these chopped glass fibers generally have
a thickness of from 5 to 20 μm, preferably of from 5 to 15 μm, more preferably of from 5 to 10 μm; and/or;
an average length of from 100 to 500 microns, or from 150 to 450 microns; and/or
an aspect ratio, defined as their average length over the largest of their average width and average thickness, of at most 5, or at most 3, or at most 2.5, or at most 2, or at most 1.5.

The morphology of the chopped glass fiber is not particularly limited. The chopped glass fiber can have a circular cross-section (“round glass fiber”) or a non-circular cross-section (“flat glass fiber”). Examples of suitable chopped flat glass fibers include, but are not limited to, glass fibers having oval, elliptical and rectangular cross sections.

### Optional Additive(s) (D)

The polyamide composition may further comprise from 0 wt % up to 20 wt % (based on the total weight of the polyamide composition) of one or more optional additive (D), such as a reinforcing agent which is different than the glass flakes, as described above, tougheners, plasticizers, light stabilizers, ultra-violet stabilizers, heat stabilizers, pigments, dyes/colorants, flame retardants, impact modifiers, lubricants, nucleating agents, antioxidants, processing aids, or any combination of two or more thereof.

In some embodiments, the polyamide composition may further comprise from 1 wt % up to 20 wt % (based on the total weight of the polyamide composition) of at least one reinforcing agent which is different than the glass flakes (C), as described above.

A large selection of reinforcing agents, also called reinforcing fillers, may be added optionally to the polyamide composition according to the present invention. They can be selected from fibrous and particulate reinforcing agents.

The optional reinforcing agent may be selected from mineral fillers (such as talc, mica, kaolin, calcium carbonate, calcium silicate, magnesium carbonate), carbon fibers, synthetic polymeric fibers, aramid fibers, aluminum fibers, titanium fibers, magnesium fibers, boron carbide fibers, rock wool fibers, steel fibers, wollastonite, glass balls (e.g., hollow glass microspheres), and glass fibers, different than the glass flakes (C) used in the polyamide composition according to the invention.

A particulate reinforcing agent may be selected from mineral fillers (such as talc, mica, kaolin, calcium carbonate, calcium silicate, magnesium carbonate) or glass balls (e.g., hollow glass microspheres).

A fibrous reinforcing filler is considered herein to be a tri-dimensional material having length, width and thickness, wherein the average length is significantly larger than both the width and thickness. Generally, such a material has an aspect ratio, defined as the ratio between the average length and the largest of the average width and average thickness of at least 5, at least 10, at least 20 or at least 50.

In some embodiments, the optional reinforcing fibers (e.g., glass fibers) may be chopped glass fibers (different than the glass flakes) having an average length greater than 0.5 mm, preferably of at least 1 mm, and up to 50 mm, or continuous glass fibers. The average length of the optional reinforcing glass fibers can be taken as the average length of the reinforcing glass fibers prior to incorporation into the polyamide composition or can be taken as the average length of the reinforcing fiber in the polyamide composition.

In some embodiments, the optional glass fibers have an average length of from 3 mm to 50 mm. In some such embodiments, the optional glass fibers have an average length of from 3 mm to 10 mm, from 3 mm to 8 mm, from 3 mm to 6 mm, or from 3 mm to 5 mm. In alternative embodiments, the optional glass fibers have an average length of from 10 mm to 50 mm, from 10 mm to 45 mm, from 10 mm to 35 mm, from 10 mm to 30 mm, from 10 mm to 25 mm or from 15 mm to 25 mm. In some embodiments, the optional glass fibers have generally an equivalent diameter of from 5 to 20 μm, preferably of from 5 to 15 μm and more preferably of from 5 to 10 μm.

All glass types, such as A, C, D, E, M, S, R, T glass or any mixtures thereof or mixtures thereof may be used. E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62-75 wt. % of SiO₂, from 16-28 wt. % of Al₂O₃ and from 5-14 wt. % of MgO. On the other hand, R, S and T glass fibers comprise less than 10 wt. % of CaO.

In some embodiments, the optional glass fiber is a high modulus glass fiber. High modulus glass fibers have an elastic modulus of at least 76 GPa, preferably at least 78 GPa, more preferably at least 80 GPa, and most preferably at least 82 GPa as measured according to ASTM D2343. Examples of high modulus glass fibers include, but are not limited to, S, R, and T glass fibers. A commercially available source of high modulus glass fibers is S-1 and S-2 glass fibers from Taishan and AGY, respectively.

The optional glass fiber can be a round glass fiber or flat glass fiber. Examples of suitable flat glass fibers include, but are not limited to, glass fibers having oval, elliptical and rectangular cross sections.

In some embodiments in which the polyamide composition further includes a flat glass fiber, the flat glass fiber has a cross-sectional longest diameter of at least 15 μm, preferably at least 20 μm, more preferably at least 22 μm, still more preferably at least 25 μm. Additionally or alternatively, in some embodiments, the flat glass fiber has a cross-sectional longest diameter of at most 40 μm, preferably at most 35 μm, more preferably at most 32 μm, still more preferably at most 30 μm. In some embodiments, the flat glass fiber has a cross-sectional shortest diameter of at least 4 μm, preferably at least 5 μm, more preferably at least 6 μm, still more preferably at least 7 μm. Additionally or alternatively, in some embodiments, the flat glass fiber has a cross-sectional shortest diameter of at most 25 μm, preferably at most 20 μm, more preferably at most 17 μm, still more preferably at most 15 μm.

In some embodiments, the optional flat glass fiber has a ratio of the longest diameter in the cross-section of the glass fiber to the shortest diameter in the same cross-section of at least 2, preferably at least 2.2, more preferably at least 2.4, still more preferably at least 3. Additionally or alternatively, in some embodiments, this ratio of the flat glass fiber is at most 8, preferably at most 6, more preferably of at most 4.

In some embodiments, in which the optional glass fiber is a round glass fiber, the glass fiber has a ratio of the longest diameter in the cross-section of the glass fiber to the shortest diameter in the same cross-section of less than 2, preferably less than 1.5, more preferably less than 1.2, even more preferably less than 1.1, most preferably, less than 1.05. Of course, the person of ordinary skill in the art will understand that regardless of the morphology of the glass fiber (e.g., round or flat), the aspect ratio cannot, by definition, be less than 1.

In some embodiments, the optional glass fiber is a round or flat glass fiber selected from the group consisting of: E-glass fiber; high-modulus glass fiber having a tensile modulus of at least 76 GPa as measured according to ASTM D2343; and combinations thereof.

In some embodiments, when the polyamide composition includes the glass flakes (C) and at least one optional reinforcing agent according to the above description, the combined content of the glass flakes+optional reinforcing agent(s) is at least 31 wt %, or at least 32 wt %, or at least 35 wt %, or at least 40 wt %, based on the total weight of the polyamide composition. In additional or alternate embodiments, the combined content of the glass flakes (C)+optional reinforcing agent(s) is at most 60 wt %, or at most 55 wt %, or at most 50 wt %, based on the total weight of the polyamide composition. In some embodiments, the combined content of the glass flakes (C)+optional reinforcing agent(s) is from 31 wt % to 60 wt %, or from 32 wt % to 55 wt %, or from 35 wt % to 55 wt %, or from 35 wt % to 50 wt %, or from 40 wt % to 55 wt %, based on the total weight of the polyamide composition.

In some embodiments, when the polyamide polymer comprises the glass flakes (C)+optional reinforcing agent(s), the weight of the optional reinforcing agent(s) in the polyamide composition is preferably not greater than 10 wt %, based on the total weight of the polyamide composition.

In some embodiments, the polyamide composition excludes a reinforcing agent which is different than the glass flakes (C), as described above.

In some embodiments, the polyamide composition excludes fibrous reinforcing agents having an average length greater than 0.5 mm, or greater than 1 mm.

In some embodiments, the polyamide composition excludes glass fibers having an average length greater than 0.5 mm, or greater than 1 mm.

In some embodiments, the polyamide composition excludes glass spheres or balls and in particular excludes hollow glass balls.

In some embodiments, the polyamide composition optionally includes from 0.1 wt % up to 10 wt %, or from 0.5 to 5 wt %, of an additive selected from the group consisting of tougheners, plasticizers, light stabilizers, ultra-violet (“UV”) stabilizers, heat stabilizers, dyes, pigments, colorants, flame retardants, impact modifiers, lubricants, nucleating agents, antioxidants, processing aids, and any combination of two or more thereof.

In some embodiments in which the polyamide composition includes one or more optional additives selected from the group consisting of tougheners, plasticizers, light stabilizers, ultra-violet (“UV”) stabilizers, heat stabilizers, pigments, dyes, pigments, colorants, flame retardants, impact modifiers, lubricants, nucleating agents, antioxidants, processing aids, and any combination of two or more thereof, the total concentration of these additives is no more than 10 wt %, no more than 5 wt %, no more than 3 wt %, no more 2 wt %, no more than 1 wt %, and/or at least 0.1 wt %, or at least 0.2 wt %, or at least 0.3 wt %, or at least 0.5 wt %.

In some preferred embodiments, the polyamide composition includes at least one impact modifier, heat stabilizer, dye, pigment, colorant, and/or lubricant.

In preferred embodiments, an additive comprising carbon black powder may be included in the polyamide composition, for example as a colorant. Such carbon black powder may be added in a form of a masterbatch including a polymeric carrier. Such masterbatch may be called “carbon black concentrate”. A carbon black concentrate may be added from 1 to 10 pph, where “pph” means parts per hundred by total weight of polyamide composition (A+B+C+D). Such carbon black powder may be electrically conductive. However the sole presence of such carbon black powder in the polyamide composition according to the invention would not result, when used on its own—that is to say, in the absence of the electrically conductive material (B)—, in sufficiently lowering the volume resistivity of such polyamide composition (or a molded article comprising it) to yield an ESD material. It is to be noted though that this additional electrically conductive carbon black powder as additive (such as a colorant) can further decrease the volume resistivity already observed with the presence of the electrically conductive material (B).

In some embodiments, the polyamide composition does not comprise an antistatic additive.

In some embodiments, the polyamide composition does not comprise an impact modifier.

In some embodiments, the polyamide composition does not comprise a flame retardant.

### Preparation of the Polyamide Composition

The invention further pertains to a method for making the polyamide composition as above detailed, said method comprising melt-blending the polyamide polymer (A1), the polyamide polymer (A2), the polyamide polymer (A3) when present, the electrically conductive material (B), the glass flakes (C), one or more optional additive(s) such as reinforcing agent(s) different than the glass flakes, a lubricant, a UV stabilizer, a heat stabilizer, an impact modifier, a dye, a pigment, a colorant, etc.

Any melt-blending method may be used for mixing polymeric ingredients and non-polymeric ingredients in the context of the present invention.

For example, polymeric ingredient(s) and non-polymeric ingredients may be fed into a melt mixer, such as single screw extruder or twin screw extruder, agitator, single screw or twin screw kneader, or Banbury mixer, and the addition step may be addition of all ingredients at once or gradual addition in batches. When the polymeric ingredient(s) and non-polymeric ingredients are gradually added in batches, a part of the polymeric ingredient(s) and/or non-polymeric ingredients is first added, and then is melt-mixed with the remaining polymeric ingredient(s) and non-polymeric ingredients that are subsequently added, until an adequately mixed composition is obtained.

If an optional reinforcing agent presents a long physical shape (for example, a long or ‘endless’ fiber), drawing extrusion molding, pultrusion to form long-fiber pellets or pultrusion to form unidirectional composite tapes may be used to prepare a reinforced composition.

### Articles and Applications

Another aspect of the present invention provides the use of the polyamide composition in an article.

The polyamide composition can be desirably incorporated into articles, preferably shaped articles.

The article can notably be used in electrical and electronic appliances, LED packaging, electrical and electronic components (including, but not limited to, power unit components for computing, data-system and office equipment and surface mounted technology compatible connectors and contacts), medical device components; and electrical protection devices for mini-circuit breakers, contactors, switches and sockets), automotive components, and aerospace components (including, but not limited to, interior cabin components).

The term “electronic device” is intended to denote a device that includes an electronic component. Certain electronic devices are not intended to be portable and used in various locations, while some are intended to be portable (“mobile”) such as being easily carried by a person.

The term “mobile electronic device” is intended to denote an electronic device that is designed to be conveniently carried by a person, such as hand-held, worn on a wrist or a nose bridge, carried in a carrier such as a case, briefcase, wallet, purse, or worn or affixed in and/or on a piece of clothing, etc, and used in various locations. Representative examples of mobile electronic devices may be selected from the group consisting of a mobile electronic phone, a personal digital assistant, a laptop computer, a tablet computer, a radio, a camera and camera accessories, a wearable computing device (e.g., a smart watch, smart glasses and the like), a calculator, a music player, a global positioning system receiver, a portable game console and console accessories, a hard drive and other electronic storage devices.

Preferred mobile electronic devices include laptop computers, tablet computers, mobile electronic phones and wearable computing devices, e.g., watches and glasses.

Components of mobile electronic devices of interest herein include, but are not limited to, antenna windows, fitting parts, snap fit parts, mutually moveable parts, functional elements, operating elements, tracking elements, adjustment elements, carrier elements, frame elements, switches, connectors, cables, housings, and any other structural part other than housings as used in a mobile electronic devices, such as for example speaker parts. In some embodiments, the device component can be of a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a camera module, a switch, or a switchpad.

In some embodiments, the electronic device can be at least a portion of an input device.

A particular embodiment of the present invention relates to an electrostatic dissipative component for an electronic device, particularly a mobile electronic device. Such an electrostatic dissipative component for an electronic device may be a molded article comprising the polyamide composition as described herein.

In some embodiments, the mobile electronic device component may also be a mobile electronic device housing. The “mobile electronic device housing” refers to one or more of the back cover, front cover, antenna housing, frame and/or backbone of a mobile electronic device. The housing may be a single article or comprise two or more components. A “backbone” refers to a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas.

In some embodiments, the mobile electronic device housing is selected from the group consisting of a mobile phone housing, an antenna housing, an antenna window, a tablet housing, a laptop computer housing, a tablet computer housing or a watch housing.

In some embodiments, the mobile electronic device component may include, for example, a radio antenna or a camera module. In this case, the radio antenna can be a WiFi antenna or an RFID antenna. In some such embodiments, at least a portion of the radio antenna or camera module is disposed on the polyamide composition. Additionally or alternatively, at least a portion of the radio antenna or camera module can be displaced from the polyamide composition.

Examples of automotive components include, but are not limited to, components in automotive electronic components, automotive lighting components (including, but not limited to, motor end caps, sensors, ECU housings, bobbins and solenoids, connectors, circuit protection/relays, actuator housings, Li-ion battery systems, and fuse boxes), traction motor and power electronic components (including, but not limited to, battery packs), electrical battery housings.

The article can be molded from the polyamide composition by any process adapted to thermoplastics, e.g., extrusion, injection molding, blow molding, rotomolding, overmolded or compression molding.

Preferred formation of the molded article or the electronic device component includes a suitable melt-processing method such as injection molding or extrusion molding of the polyamide composition, injection molding being a preferred shaping method.

In some embodiments, the molded article or the electronic device component according to the invention has at least one of the following properties.

In some embodiments, the polyamide-based molded article or the electronic device component has a volume resistivity (measured according to ASTM D257) of at least 1·10⁺⁵ Ω·cm, or at least 1.5·10⁺⁵ Ω·cm, and/or of at most 5·10⁺¹² Ω·cm, or at most 3·10⁺¹² Ω·cm, or at most 1·10⁺¹² Ω·cm. In some embodiments, the polyamide-based molded article or the electronic device component has a volume resistivity of from 1·10⁺⁵ Ω·cm up to 5·10⁺¹² Ω·cm. The volume resistivity is therefore tunable over about at least 7 orders of magnitude by selecting the conductive material with a specific volume resistivity and varying the electrically conductive material content in the polyamide composition used to make the molded article.

In some embodiments, the molded article or the electronic device component according to the invention has a mold shrinkage (in %) in transverse direction, determined according to ISO 294 (ASTM D955) of at most 0.35%, or at most 0.33%, or at most 0.32%, or at most 0.31%.

In some embodiments, the molded article or the electronic device component according to the invention has a ratio of mold shrinkage in flow direction versus shrinkage in transverse direction is greater than 55%, or greater than 60%, or greater than 65%, wherein the mold shrinkages (in %) in flow direction and in transverse direction are determined according to ISO 294 (ASTM D955).

In some embodiments, the polyamide-based molded article or the electronic device component according to the invention, resulting from molding the polyamide composition comprising at least one polyamide mixture (A), the electrically conductive material (B), glass flakes (C), optionally additive(s) (D) (such as a heat stabilizer, a lubricant, an impact modifier, a UV stabilizer, a dye, a pigment, a colorant, etc) has a lower ratio of mold shrinkage in flow direction versus shrinkage in transverse direction (in %) compared to a similar composition but without the electrically conductive material (B).

In some embodiments, the molded article or the electronic device component according to the invention has a warpage of at most 0.1, or at most 0.09. The warpage is the absolute value of the percent shrinkage in the transverse direction minus the percent shrinkage in the flow direction of a molded article or the electronic device component comprising the polyamide composition, both of % shrinkages being preferably determined according to ASTM D955.

In some embodiments, the polyamide-based molded article or the electronic device component according to the invention, resulting from molding the polyamide composition comprising at least one polyamide mixture (A), the electrically conductive material (B), glass flakes (C), and optionally additive(s) (D) (such as a heat stabilizer, a lubricant, an impact modifier, a UV stabilizer, a dye, a pigment, a colorant, etc) has a lower warpage (in %) compared to a similar composition but without the electrically conductive material (B).

In some embodiments, the polyamide-based molded article or the electronic device component according to the invention, resulting from molding the polyamide composition comprising the polyamide mixture (A), the electrically conductive material (B), glass flakes (C), optionally additive(s) (D) (such as a heat stabilizer, a lubricant, an impact modifier, a UV stabilizer, a dye, a pigment, a colorant, etc) has improved tensile modulus, improved tensile strength, improved flexural modulus, improved flexural strength, and/or improved impact properties (notched and unnotched values) compared to a similar composition but without the electrically conductive material (B).

In some embodiments, the polyamide-based molded article or the electronic device component according to the invention, resulting from molding the polyamide composition has one or more of the following properties:
a tensile modulus (measured according to ISO 527) of at least 15 GPa or at least 16 GPa and/or at most 30 GPa, or at most 26 GPa;
a tensile strength (measured according to ISO 527) of at least 150 MPa, or at least 156 MPa and/or at most 210 MPa, or at most 200 MPa, or at most 190 MPa;
a flexural modulus (measured according to ISO 178) of at least 14 GPa and/or at most 30 GPa, or at most 25 GPa;
a flexural strength (measured according to ISO 178) of at least 200 MPa, or at least 225 MPa and/or at most 350 MPa or at most 330 MPa;
a notched impact (measured according to ISO 180) of at least 3 kJ/m² or at least 3.2 kJ/m² and/or at most 6 kJ/m²;
an unnotched impact (measured according to ISO 180) of at least 21.5 kJ/m² or at least 27 kJ/m² and/or at most 40 kJ/m².

Regardless of the molding technique employed to make the article, it has been discovered that in some embodiments, the molded article or the electronic device component according to the invention may have a relatively smooth surface, which may be represented by its surface glossiness. For example, the surface glossiness as determined using a gloss meter at an angle of from about 80° to about 85° may be at least 35%, or at least about 38%, or at least 40%. The surface glossiness measured at an angle of from about 80° to about 85° may be at most 99%, or at most 98%, or at most 97%, or at most 96%, or at most 95%, or at most 94%, or at most 93%, or at most 92%, or at most 91%, or at most 90%. Preferred ranges of glossiness measured at an angle of from about 80° to about 85° may be from about 40% to 95%.

In some embodiments, when the polyamide composition omits a polyamide (A3), the surface glossiness measured at an angle of about 85° may range from about 40% to 60%. In other embodiments, when the polyamide composition contains the polyamide (A3), the surface glossiness measured at an angle of about 85° may range from about 60% to 95%, preferably from about 65% to 90%.

While it is conventionally believed that parts having a smooth surface would not possess sufficiently good mechanical properties, to the contrary however, the polyamide-based molded article of the present invention has been found to possess excellent mechanical properties, as previously described and illustrated in the Examples.

### Use of the Polyamide Composition

In some embodiments, the polyamide composition or article can be used for manufacturing an electronic device component, preferably a mobile electronic device component, as described above.

Method for Reducing Warpage and/or Mold Shrinkage of a Polyamide Composition

Another aspect of the present invention relates to a method for reducing warpage and/or mold shrinkage of a molded article made from a polyamide composition, comprising blending the polyamide mixture (A), the glass flakes (C), and optionally additive(s) (D) with the conductive material (B) (preferably which comprises milled carbon fibers) to form a molding composition before subjecting the molding composition to molding, preferably injection molding to form a molded article. The blending is preferably carried out by melt-blending as described above.

### Method for Reducing Volume Resistivity of a Polyamide Composition

Another aspect of the present invention relates to a method for reducing volume resistivity of a molded article made from a polyamide composition, comprising blending the polyamide mixture (A), the glass flakes (C) and optionally at least one additive (D) with the electrically conductive material (B) (preferably which comprises carbon fibers or milled carbon fibers) to form a molding composition before subjecting the molding composition to molding, preferably injection molding to form a molded article. The blending is preferably carried out by melt-blending as described above.

### EXAMPLES

The invention will now be described with reference to the following examples, whose purpose is merely illustrative and not intended to limit the scope of the invention.

The following examples demonstrate:
reduced volume resistivity to yield an ESD material,
improved mechanical properties including
   improved impact properties,
   improved tensile properties (tensile modulus, tensile strength),
   improved flexural properties (flexural modulus, flexural strength),
improved mold shrinkage properties
   improved shrinkage (in/in % shrinkage in flow and in transverse direction)
   improved shrinkage ratio (% shrinkage in flow/% shrinkage in transv.)
   decreased warpage (absolute value of the difference from shrinkage in transverse direction and shrinkage in flow direction.

Some examples further demonstrate:
excellent surface properties
   high glossiness
good CLTE (dimensional stability).
   As used in the Examples, “E” denotes an example embodiment of the present invention and “CE” denotes a comparative example.

### Raw Materials

The raw materials used to form the samples as provided below:

### Polyamides:

Polyamide (A1): PA6T/66 (Tg=100° C., Tm=311° C.) as Amodel® 4002 from Solvay Specialty Polymers (made from polycondensation of 65 mol % terephthalic acid and 35 mol % adipic acid with hexamethylene diamine)
Polyamide (A2): PA12 (Tg=40-50° C., Tm=178-180° C.) as Vestamid L-1700 from Evonik
Polyamide (A3): PA610 (Tg=50-60° C., Tm=220° C.) as Radipol DC 40 from Radici

### Electrically Conductive Material (B):

Electrically Conductive Material (“B1”): 300-micron milled carbon fibers in granulates, commercially available as APPLY CARBON CF MLD 300 G U1 recycled carbon fiber granulate from Procotex; characterized by a mean size of about 300±40 microns, a carbon content of about 94 wt %, a mono-filament fiber's diameter of about 7±2 microns, and an average volume resistivity of 15·10⁻³ ohm·m.
Electrically Conductive Material (“B2”): APPLY CARBON chopped Carbon Fibers CF.OS.U1-6 MM, from Procotex

### Glass Flakes (C):

MEG160FY-M03 from NSG with an average length of 160 microns (flat surface) and a thickness of 0.7 microns

### Additives (D)

Additive 1 (“D1”): a lubricant (LLDPE GRSN-9820 from Dow)
Additive 2 (“D2”): a heat stabilizer (Irganox® 1010 from BASF)
Additive 3 (“D3”): carbon black concentrate Plasblak UN2014 from Cabot (carbon black in a polyolefin carrier)
Additive 4 (“D4”): carbon black concentrate CPTA-25759-CA1000 from Clariant comprising 80 wt % Amodel® 1006 and 20 wt % carbon black
Optional additives: pigments/dyes may be added to the polyamide composition.

### Test Methods

Tensile properties—ISO 527
   Tensile modulus, tensile strength, and elongation at break were measured on 5 injection molded ISO Type 1a tensile specimens (total length=170 mm, gauge length=50 mm, testing section width=10 mm, and thickness=4 mm)
Flexural properties—ISO 178
   Flexural modulus, Flexural strength, and flexural elongation at break were measured on 5 injection molded ISO type 1A bars (length of 80±2 mm, width of 10±0.2 mm, thickness of 4±0.2 mm)
Impact strength—ISO 180
   Notched and un-notched Izod impact strength properties were measured in kJ/m² using 10 injection molded ISO type 1A bars (length of 80±2 mm, width of 10±0.2 mm, thickness of 4±0.2 mm).
CLTE—ASTM E831
   The dimensional changes were measured on injection molded specimens having dimensions of 3.2 mm thickness by 12.7 mm width by 12.0 to 13.0 mm length. A TMA was used to measure the CLTE from 0° C. to 50° C. with a heating rate of 5° C./min in the flow and transverse directions.
Mold shrinkage—ISO 294 (ASTM D955)
   Mold shrinkage (mold shrinkage in Flow Direction (%) and in Transverse Direction (%)) was measured on 5 injection molded plaques with dimensions 60 mm width by 60 mm length by 2 mm thick.
Warpage is determined as follows: polyamide compositions were injection molded into plaques having dimensions of 60 mm×60 mm×2 mm according to ASTM D955, as detailed above. The warpage was calculated as the absolute value of the percent shrinkage in the transverse direction minus the percent shrinkage in the flow direction.
Gloss testing method—ASTM D523
   The shrinkage plaques (60 mm*60 mm*2 mm) were used to measure gloss. Any gloss meter may be used to measure the glossiness of the surface of these plaques. Glossiness readings were taken at two different locations of the surface at an incident light angle of 20, 60° or 85° relative to the surface of the plaque, with two repeat measurements at each location. The average of the readings was taken for calculating the glossiness.
Volume resistivity—ASTM D257
   Volume resistivity was measured on 5 injection molded plaques with dimensions 4″×4″×⅛″ (length×width×thickness) or 60 mm×60 mm×2 mm (length×width×thickness)

### Example 1—Polyamide Compositions with Polyamide Mixture: PA6T/66 (as A1) and PA12 (as A2)

In this example, several samples of polyamide compositions were prepared in which polyamide A1 (PA6T/66) was compounded (melt-blended) with polyamide A2 (PA12), glass flakes (C), milled carbon fibers (B1), a lubricant as additive (D1), a heat stabilizer as additive (D2). Samples E1 and E2 further contained 1 pph of carbon black concentrate (D3). The weight ratios of semi-aromatic polyamide (A1) to aliphatic polyamide (A2) were 7.2 and 6.8 in Samples E1 and E2, respectively.

For comparison, Sample CE0 without milled carbon fibers was prepared. The weight ratio of semi-aromatic polyamide (A1) to aliphatic polyamide (A2) was 8.8 in Sample CE0.

The melt-blending was carried out using a Coperion® ZSK-26 co-rotating twin-screw extruder and the compounded samples were subsequently molded according to ASTM D3641.

Table 1 displays the polyamide compositions and also the following properties: the volume resistivity, the mechanical properties including impact properties, the tensile modulus, the tensile strength, the tensile elongation at break, the mold shrinkage properties (in/in % in flow direction and in transverse direction), the warpage and shrinkage ratio (% shrinkage in flow/% shrinkage in transv.) of the composition Samples CE0 and E1-E2.

As shown in Table 1, the addition of 8 wt % and 10 wt % of milled carbon fibers to the polyamide composition in Samples E1, E2 decreased the volume resistivity compared to Sample CE0 without milled carbon fibers. The Samples E1, E2 were electrostatic dissipative because their volume resistivity was within the range of 10⁺⁵ to 5·10⁺¹² ohm·cm. Sample CE0 was not an ESD material.

Moreover, the impact properties (notched Izod and un-notched izod), the tensile modulus of elasticity and the tensile strength of Samples E1, E2 with 8 wt % and 10 wt % of milled carbon fibers (B1) were improved compared to Sample CE0 without milled carbon fibers.

TABLE 1
Compositions and Properties of Samples with PA6T/66 + PA12

| Component | CE0 | E1 | E2 |
|---|---|---|---|
| (A) - polyamide mixture (wt %) | 49 | 41 | 39 |
| (A1) - PA6T/66 (wt %) | 44 | 36 | 34 |
| (A2)- PA12 (wt %) | 5 | 5 | 5 |
| (A1) wt % based on A1 + A2 | 89.8 | 87.8 | 87.2 |
| (A2) wt % based on A1 + A2 | 10.2 | 12.2 | 12.8 |
| (B1) milled carbon fibers (wt %) | — | 8 | 10 |
| (C) glass flakes (wt %) | 50 | 50 | 50 |
| (D1) lubricant (wt %) | 0.5 | 0.5 | 0.5 |
| (D2) heat stabilizer (wt %) | 0.5 | 0.5 | 0.5 |
| (D3) carbon black concentrate (pph*) | 1 | 1 | 1 |

Properties

| Vol. Resistivity (ohm · cm) | | 1.81 | 7.04 | 2.2 |
|---|---|---|---|---|
| | | 10⁺¹⁶ | 10⁺⁷ | 10⁺⁵ |
| Thickness (mm) | | 1.96 | 2.02 | 2.01 |
| Notched Impact (kJ/m²) | | 2.9 | 4.7 | 4.7 |
| Un-notched Impact (kJ/m²) | | 21.4 | 33.1 | 32.4 |
| Shrinkage (in/in, %) in flow direction | | 0.24 | 0.19 | 0.19 |
| Shrinkage (in/in, %) in transverse | | 0.44 | 0.28 | 0.26 |
| direction | | | | |
| Shrinkage Ratio (%, flow/transv.) | | 56% | 67% | 72% |
| Warpage (%) | | 0.19 | 0.09 | 0.07 |
| Tensile Modulus of Elasticity (GPa) | | 15.9 | 24.1 | 25.7 |
| Tensile Strength (MPa) | | 151 | 181 | 182 |
| Tensile Elongation at break (%) | | 1.2 | 1.0 | 0.9 |
| Gloss | at 20° | 4.2 | 2.8 | 2.2 |
| | at 60° | 23.2 | 18.4 | 15.9 |
| | at 85° | 59.0 | 46.7 | 40.4 |

*“pph” means parts per hundred by total weight of A + B1 + C + D1 + D2 + D3

The tensile elongation at break (%) of Samples E1, E2 with 8 wt % and 10 wt % of carbon fibers was slightly lower compared with Sample CE0 without milled carbon fibers.

Furthermore, the mold shrinkage properties also improved with the addition of milled carbon fibers.

With the addition of 8 and 10 wt % milled carbon fibers (B1), the transverse mold shrinkage of the polyamide compositions in Samples E1, E2 was reduced by 36 and 39% compared to Sample CE0, indicating that the addition of 8-10 wt % milled carbon fibers (B1) reduced the transverse mold shrinkage. Moreover, the mold shrinkage in flow direction of the polyamide compositions in Samples E1, E2 was also reduced compared to Sample CE0 without milled carbon fibers (B1), although in a lesser extent as what was observed for the transverse mold shrinkage.

The shrinkage ratios in flow direction versus in transverse direction of Samples E1, E2 were 67% and 72%, much closer to isotropic shrinkage compared to 56% for Sample CE0 without milled carbon fibers.

The warpage also decreased with the addition of milled carbon fibers. The warpage of Samples E1, E2 was 0.09% and 0.07%, respectively, much lower than the warpage of Samples CE0 (0.19%) without milled carbon fibers.

The surface gloss of Samples E1, E2 with 8 wt % and 10 wt % of carbon fibers was lower compared with the value (59% at) 85° of Sample CE0 without milled carbon fibers. However the gloss measured at 85° for Samples E1, E2 was still at least 40%.

The results obtained with Samples E1, E2 demonstrated that by the addition of 8 and 10 wt % milled carbon fibers and 50 wt % glass flakes in polyamide compositions comprising PA6T/66 and PA12, a suitable ESD material could be obtained while improving impact resistance, improving tensile modulus and tensile strength and also improving mold shrinkage properties (lower warpage and approaching isotropic shrinkage).

Melting temperature (Tm) was measured according to ASTM D3418 and for samples CE0, E1 and E2, the Tm values were between 323 and 326° C. There was no negative impact on Tm caused by the addition of the milled carbon fibers in polyamide compositions comprising PA6T/66 and PA12.

### Example 2—Polyamide Compositions with PA6T/66+PA12+PA610

In this example, several Samples E4-E6 of polyamide compositions were prepared in which polyamide A1 (PA6T/66) was compounded (melt-blended) with polyamide A2 (PA12), polyamide A3 (PA610), glass flakes (C), chopped carbon fibers (B2) and a lubricant as additive (D1). Samples E5 further contained 10 pph of carbon black concentrate (D4), while the other Samples E4 and E6 contained 1 pph of carbon black concentrate (D4). The weight ratios of semi-aromatic polyamide (A1) to aliphatic polyamides (A2)+ (A3) were 1.64, 1.67, and 1.67 in Samples E4, E5 and E6, respectively.

For comparison, Sample CE3 without carbon fibers (B2) was prepared.

The melt-blending was carried out using a Coperion® ZSK-26 co-rotating twin-screw extruder and the compounded samples were subsequently molded according to ASTM D3641.

Table 2 displays the polyamide compositions and also the following properties: the volume resistivity for which the thickness of the sample was about 2 mm, the mechanical properties including impact properties, the tensile properties (modulus, strength, elongation at break), the flexural properties (modulus, strength, elongation at break), the CLTE (0-50° C.) properties in flow and transverse directions, the mold shrinkage properties (in/in % in flow direction and in transverse direction), the warpage and shrinkage ratio (% shrinkage in flow dir./% shrinkage in transv. dir.) of the composition Samples CE3 and E4-E6.

As shown in Table 2, the addition of 8 and 10 wt % of chopped carbon fibers to the polyamide composition in Samples E4-E6 decreased the volume resistivity compared to Sample CE3 without chopped carbon fibers. Samples E4-E6 were electrostatic dissipative because their volume resistivity was within the range of 10⁺⁵ to 5·10⁺¹² ohm·cm. Sample CE3 was not an ESD material.

The combination of 8 wt % of carbon fibers and 10 pph carbon black in the polyamide composition Sample E5 decreased the volume resistivity by 37% compared to Sample E6 which contains 8 wt % chopped carbon fibers and only 1 pph of carbon black. Therefore it was observed that increasing the amount of carbon black concentrate from 1 pph to 10 pph could reduce the volume resistivity.

Moreover, the impact properties (notched Izod and un-notched izod), the tensile modulus, the tensile strength, the flexural modulus and the flexural strength of Samples E4-E6 with 8 wt % or 10 wt % of chopped carbon fibers (B2) were improved compared to Sample CE3 without chopped carbon fibers.

The tensile elongation at break (%) of Samples E4-E6 with 8 wt % or 10 wt % of chopped carbon fibers (B2) was slightly lower compared with Sample CE3 without chopped carbon fibers. The flexural elongation at break (%) of Samples E4-E6 with 8 wt % or 10 wt % of carbon fibers (B2) was either the same or slightly lower compared with Sample CE3 without carbon fibers.

TABLE 2
Compositions and Properties of Samples with PA6T/66 + PA12 + PA610

| Component | CE3 | E4 | E5 | E6 |
|---|---|---|---|---|
| (A) - polyamide mixture (wt %) | 49.5 | 44.5 | 46.5 | 46.5 |
| (A1) - PA6T/66 (wt %) | 31.20 | 27.65 | 29.05 | 29.05 |
| (A2)- PA12 (wt %) | 5 | 5 | 5 | 5 |
| (A3)- PA610 (wt %) | 13.3 | 11.85 | 12.45 | 12.45 |
| (A1) wt % based on A1 + A2 + A3 | 63.0% | 62.1% | 62.5% | 62.5% |
| (A2) wt % based on A1 + A2 + A3 | 10.1% | 11.2% | 10.8% | 10.8% |
| (A3) wt % based on A1 + A2 + A3 | 26.9% | 26.6% | 26.8% | 26.8% |
| (B2) carbon fibers (wt %) | — | 10 | 8 | 8 |
| (C) glass flakes (wt %) | 50 | 45 | 45 | 45 |
| (D1) lubricant (wt %) | 0.5 | 0.5 | 0.5 | 0.5 |
| (D4) carbon black concentrate (pph*) | 1 | 1 | 10 | 1 |

Properties

| Vol. Resistivity (ohm · cm) | | 2.66 | 1.38 | 7.52 | 1.19 |
|---|---|---|---|---|---|
| | | 10⁺¹⁶ | 10⁺⁶ | 10⁺⁷ | 10⁺⁸ |
| Notched Impact (kJ/m²) | | 3.1 | 5.3 | 4.7 | 5.3 |
| Un-notched Impact (kJ/m²) | | 26.0 | 38.2 | 34.5 | 38.0 |
| CLTE [ppm/C] in flow direction | | 24 | 15 | 34 | 15 |
| CLTE [ppm/C] in transv. direction | | 30 | 32 | 33 | 29 |
| Shrinkage (in/in, %) in flow direction | | 0.23 | 0.18 | 0.17 | 0.25 |
| Shrinkage (in/in, %) in transv. direction | | 0.31 | 0.31 | 0.33 | 0.31 |
| Shrinkage Ratio (%, flow/transv.) | | 75% | 58% | 51% | 82% |
| Warpage | | 0.08 | 0.13 | 0.16 | 0.05 |
| Tensile Modulus of Elasticity (GPa) | | 14.8 | 25.3 | 22.0 | 23.7 |
| Tensile Strength (MPa) | | 148 | 206 | 195 | 198 |
| Tensile Elongation at break (%) | | 1.5 | 1.3 | 1.4 | 1.3 |
| Flexural Modulus [GPa] | | 13.8 | 23.2 | 20.5 | 21.4 |
| Flexural Strength [MPa] | | 223 | 329 | 306 | 311 |
| Flexural elongation at break (%) | | 1.9 | 1.8 | 1.9 | 1.8 |
| Gloss | at 20° | 33.0 | 17.0 | 21.8 | 15.8 |
| | at 60° | 67.1 | 52.4 | 55.6 | 49.9 |
| | at 85° | 86.8 | 80.5 | 82.9 | 76.8 |

*“pph” means parts per hundred by total weight of A + B2 + C + D1 + D4

For Sample E6 (8 wt % B2, 1 pph D4), the shrinkage ratio in flow direction versus in transverse direction was 82%, much closer to isotropic shrinkage compared to 75% for Sample CE3 without milled carbon fibers. The warpage 0.05% of Sample E6 was also improved and lower than the warpage of Sample CE3 (0.08%) without chopped carbon fibers.

On the other end, for Sample E4 (10 wt % B2, 1 pph D4) and Sample E5 (8 wt % B2, 10 pph D4), the shrinkage properties were not improved. The addition of 10 wt % chopped carbon fibers+1 pph carbon black concentrate or 8 wt % chopped carbon fibers+10 pph carbon black concentrate resulted in reducing the shrinkage in the flow direction, but did not reduce the shrinkage in transverse direction to the same extent. It is likely that the greater amount of carbon fibers (in E4) and also the use of 10-fold higher amount of carbon black powder (in E5) favored alignment of fibers along the flow direction. As a result, for Samples E4 and E5, the shrinkage ratios (58%, 51%) were lower and the warpages (0.13%, 0.16%) were higher than for the comparative Sample CE3.

The surface gloss of Samples E4-E6 with 8 wt % and 10 wt % of carbon fibers was lower compared with the value (86.8% at) 85° of Sample CE3 without milled carbon fibers. However the gloss measured at 85° for Samples E4-E6 was still at least 75%, indicative of retention of a smooth surface appearance.

The results obtained with Samples E4-E6 demonstrated that by the addition of 8 and 10 wt % chopped carbon fibers and 50 wt % glass flakes in polyamide compositions comprising PA6T/66, PA12 and PA610, a suitable ESD material could be obtained while improving impact resistance, improving tensile modulus and tensile strength, improving flexural modulus and flexural strength, and retaining an excellent surface property (high glossiness).

Sample E5 exhibited also improving mold shrinkage properties (lower warpage and approaching isotropic shrinkage).

It is also observed, when comparing Example 2 with Example 1, that the addition of PA610 (as polyamide (A3)) to the mixture of PA6T/66 and PA12 (as polyamides (A1) and (A2)) resulted in an ESD material with a smooth surface (high gloss).

Tm was measured according to ASTM D3418. For samples CE3 and E4-E6, the Tm values were between 336 and 340° C. There was no negative impact on Tm caused by the addition of the chopped carbon fibers in polyamide compositions comprising PA6T/66, PA12 and PA610.

While preferred embodiments of this invention have been shown and described, modifications thereof can be made by one skilled in the art without departing from the spirit or teaching of this invention. The embodiments described herein are exemplary only and are not limiting. Many variations and modifications of compositions, articles, and methods are possible and are within the scope of the invention. Accordingly, the scope of protection is not limited by the description set out above, but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. Any incorporation by reference of documents above is limited such that no subject matter is incorporated that is contrary to the explicit disclosure herein.

The disclosure of all patent applications, and publications cited herein are hereby incorporated by reference, to the extent that they provide exemplary, procedural or other details supplementary to those set forth herein. Should the disclosure of any patents, patent applications, and publications which are incorporated herein by reference conflict with the description of the present application to the extent that it may render a term unclear, the present description shall take precedence.

1. A polyamide composition comprising:
(A) from 20 to 69 wt % of a polyamide mixture comprising:
(A1) from 60 to 90 wt % of at least one semi-aromatic polyamide polymer,
(A2) from 10 to 40 wt % of at least one aliphatic polyamide polymer,
(A3) from 0 to 30 wt % of at least one aliphatic polyamide polymer different from the aliphatic polyamide polymer (A2),
wherein the respective wt % of each of the polyamides (A1), (A2) and (A3) is based on the total weight of the combination of polyamides (A1), (A2) and (A3);
(B) from 1 to 20 wt % of an electrically conducting material;
(C) from 30 to 55 wt % of glass flakes; and
(D) from 0 to 10 wt % of additives,
wherein the respective wt % of A, B, C and D are based on the total weight of the polyamide composition.

2. The polyamide composition of claim 1, wherein the semi-aromatic polyamide (A1) comprises a polyamide selected from the group consisting of PA10T/10I, PA10T, PA6T/6I, PA6T, PA9T, PA12T, PA10T/66, PA6T/66, PA6I, PA12I, PAMXD6, PAPXD10, and any combination thereof.

3. The polyamide composition of claim 1, wherein the semi-aromatic polyamide (A1) comprises a polyphthalamide.

4. The polyamide composition of claim 1, wherein the aliphatic polyamide polymer (A2) comprises PA12.

5. The polyamide composition of one of claims 1 to 4, comprising claim 1, wherein the polyamide composition comprises the aliphatic polyamide polymer (A3) being different from the aliphatic polyamide polymer (A2), and wherein the aliphatic polyamide polymer (A3) is selected from the group consisting of PA610, PA612, PA1010, PA510, PA66, PA1012, and any combination thereof.

6. The polyamide composition of claim 1, wherein the glass flakes content is from 35 wt % to 55 wt %, based on the total weight of the polyamide composition.

7. The polyamide composition of claim 1, wherein the polyamide composition comprises the at least one additive selected from the group consisting of a reinforcing agent different than the glass flakes (C), tougheners, plasticizers, light stabilizers, ultra-violet stabilizers, heat stabilizers, pigments, colorants, dyes, flame retardants, impact modifiers, lubricants, nucleating agents, antioxidants, processing aids, and any combination of two or more thereof.

8. The polyamide composition of claim 1, wherein the electrically conductive material (B) has a volume resistivity, measured according to ASTM D257, of less than 2·10⁻² Ω·cm.

9. The polyamide composition of claim 1, wherein the electrically conductive material (B) has at least one tri-dimensional structure selected from the group consisting of fibers, milled or chopped fibers, flakes, powders, microspheres, nano-tubes, nano-particles, nano-fibers, nano-flakes, nano-ropes, nano-ribbons, nano-fibrils, nano-needles, nano-sheets, nano-rods, carbon nano-cones, carbon nano-scrolls, nano-platelets, nano-dots, dendrites, discs or any other tri-dimensional body, singly or in combination.

10. The polyamide composition of claim 1, wherein the electrically conductive material (B) comprises carbon-based structures selected from the group consisting of: carbon-based fibers, carbon nano-tubes (CNTs), carbon nano-fibers, carbon nano-ropes, carbon nano-ribbons, carbon nano-fibrils, carbon nano-needles, carbon nano-sheets, carbon nano-rods, carbon nano-cones, carbon nano-scrolls, carbon nano-ohms, conductive carbon black powder, graphite fibrils, graphite nano-platelets, nano-dots, graphenes, and any combination of at least two or more thereof.

11. The polyamide composition of claim 1, comprising
from 25 to 55 wt % of the polyamide mixture (A);
from 5 to 15 wt % of the electrically conducting material (B);
from 40 to 55 wt % of the glass flakes (C); and
from 0 to 10 wt % of one or more additives (D);
or
from 30 to 50 wt % of the polyamide mixture (A);
from 5 to 15 wt % of the electrically conducting material (B);
from 45 to 50 wt % of the glass flakes (C); and
from 0 to 10 wt % of one or more additives (D).

12. The polyamide composition of claim 1, wherein the polyamide mixture (A) comprises:
A1) from 85 to 90 wt % of PA6T/66,
A2) from 10 to 15 wt % of PA12,
wherein the wt % of each of the polyamides (A1) and (A2) is based on the total weight of
the combination of polyamides (A1) and (A2).
or
A1) from 60 to 65 wt % of PA6T/66,
A2) from 10 to 15 wt % of PA12,
A3) from 20 to 30 wt % of PA610,
wherein the wt % of each of the polyamides (A1), (A2) and (A3) is based on the total weight of the combination of polyamides (A1), (A2) and (A3).

13. A method for making the polyamide composition of claim 1, comprising melt-blending the polyamide mixture (A), the electrically conductive material (B), the glass flakes (C), and any optional additive (D).

14. A molded article comprising the polyamide composition of claim 1, having a volume resistivity, measured according to ASTM D257, of from 1·10⁺⁵ Ω·cm up to 5·10⁺¹² Ω·cm.

15. A mobile electronic device component comprising the polyamide composition of claim 1, having a volume resistivity, measured according to ASTM D257, of from 1·10⁺⁵ Ω·cm up to 5·10⁺¹² Ω·cm.

16. The polyamide composition of claim 2, wherein the semi-aromatic polyamide (A1) comprises a polyphthalamide selected from the group consisting of PA6T/6I, PA6T, PA9T, PA12T, PA10T/66, PA6T/66, PA6I, and any combination thereof.

17. The polyamide composition of claim 5, wherein the aliphatic polyamide polymer (A3), being different from the aliphatic polyamide polymer (A2), is selected from the group consisting of PA610, PA612, PA510, PA66 and any combination thereof.

18. The polyamide composition of claim 8, wherein the electrically conductive material (B) has a volume resistivity, measured according to ASTM D257, of from 1·10⁻⁴ Ω·cm up to 20·10⁻⁴ Ω·cm.

19. The polyamide composition of claim 10, wherein the electrically conductive material (B) comprises carbon-based structures selected from the group consisting of: continuous carbon fibers, chopped carbon fibers, milled carbon fibers, milled/chopped carbon fibers in granulates, carbon nano-tubes (CNTs), carbon black powder, and any combination thereof.
